(19) United States
(12) Patent Application Publication
(10) Pub. No.: US 2021/0404590 A1
(43) Pub. Date: Dec. 30, 2021

(54) METHOD AND APPARATUS FOR PREVENTING BASEMENT DRAIN OVERFLOW

(71) Applicant: Russell E. Cooper, Akron, OH (US)

(72) Inventor: Russell E. COOPER, Akron, OH (US)

(21) Appl. No.: 17/360,340

(22) Filed: Jun. 28, 2021

Related U.S. Application Data
(60) Provisional application No. 63/045,477, filed on Jun. 29, 2020.

(51) Int. Cl. F16L 55/11

(52) U.S. Cl. CPC F16L 55/1141

(57) ABSTRACT

An inflatable system is described herein, including a body, a top, a bottom, an interior cavity, and a fluid inlet. In one aspect of the present teaching, the top and the bottom are on opposite sides of the body, approximately parallel to one another. The stem opening is located on the top of the body, wherein the stem opening allows the entry of fluid into the interior cavity of the body. The inflatable system is made of a material which allows for stretching when the inflatable system is inflated.

### I. BACKGROUND

This application claims priority to a provisional patent application, Ser. No. 63/045,477, filed Jun. 29, 2020, the contents of which are incorporated by reference. The present subject matter is directed to basement flooding. More specifically, the present technology is directed to apparatuses and methods for preventing basement drain overflow.

Basements are more likely to take on water than any other part of a home because they are typically below grade, i.e., located below the ground's surface. While drainage provisions do not eliminate the possibility of flooding entirely, they are usually made during the construction of a new home in an attempt to prevent standing water downstairs. Older homes constructed before building codes required basement drainage are at an even greater risk of water getting in and staying in the basement. And, once your basement has been penetrated, the lingering moisture can wreak havoc in ways ranging from damaged possessions to mold growth.

An exterior drain tile, which is installed around the perimeter of a foundation, is a highly effective way of collecting groundwater and draining it away before it can seep into the basement. After the foundation walls have been poured, the contractor will position a flexible perforated drainpipe all the way around the foundation at the bottom of the wall. Gravel placed around and on top of the pipe filters out dirt. Then, beneath that, the pipe collects whatever water pools at the bottom of the foundation walls and directs it to a collection pit, where it gets pumped back to the surface by means of a sump pump.

Interior French drains are often installed when existing homes start to have basement water problems. But, if one lives in an area that gets a lot of rain, it does not hurt to install one when the home is built. Similar to an exterior drain tile, an interior French drain features a perforated pipe that carries water to a collection pit where it can be pumped to the surface. This type of drain is located along the interior perimeter of the basement and lies below floor level. Again, the pipe must be surrounded by gravel or crushed stone to keep mud particles from filtering through. A trench approximately 1-foot-wide and 1-foot deep is necessary to contain the drainage pipe and the gravel. While some drains are covered with a grate, which can be removed for future maintenance, others are left uncovered if the basement is used only for storage. When finishing-out the basement is desired, walls are typically framed on the inside of the drain, which reduces square footage slightly but keeps the drain channel out of the living area.

Floor drains are most often installed during original construction, often in the utility area, to drain away excess water in the basement. The concrete floor around the drain gently slopes towards it, encouraging water to collect there and drain out. Most homes built today are required by local code to have floor drains that lead to a collection pit where a sump pump caries the water to the surface. Previously, homes may have floor drains that are connected to the main sewer system, but that is rarely allowed anymore because the sewer can back up in the floor drain.

Each type of basement drain listed above directs water to a collection pit where it must then be pumped to the surface. The sump pump removes water from inside a basement or along exterior walls, and it can come in two basic setups: submersible and pedestal.

A submersible sump pump is placed in a collection pit located below floor level. Most pits are approximately two feet wide and one-and-a-half feet deep, although pits up to three feet deep can be installed if groundwater is a problem. A small pit will fill up more quickly, causing the pump to cycle on more frequently, but a deeper pit is more difficult to clean out and maintain. When the water in the collection pit reaches a certain level (usually a few inches), the sump pump kicks on and pumps the water through a pipe or hose to the surface of the yard, where it drains away naturally.

A pedestal pump attaches to a pole and sits an average of four to eight inches above the collection pit. A float rises with the level of the water and then, when it reaches a certain height, activates the sump pump to push the water to the surface.

### II. SUMMARY

It is still desirable, however, to provide a system that prevents water from backing up into the basement and causing flooding.

Still other benefits and advantages of the present subject matter will become apparent to those skilled in the art to which it pertains upon a reading and understanding of the following detailed specification.

### III. BRIEF DESCRIPTION OF THE DRAWINGS

The present teachings are described hereinafter with reference to the accompanying drawings.

FIG. 1 is a cutaway view of the system;

FIG. 2 is a cutaway view of the system in a sewer drain;

FIG. 2A is perspective view of an air pump;

FIG. 3 is a perspective view of the inflated system;

FIG. 4 is a cross sectional view of a toilet;

FIG. 4A is a cross sectional view of the toilet with the system inflated; and

FIG. 4B is an exploded cutaway view of the inflated system in a toilet pipe.

### IV. DETAILED DESCRIPTION

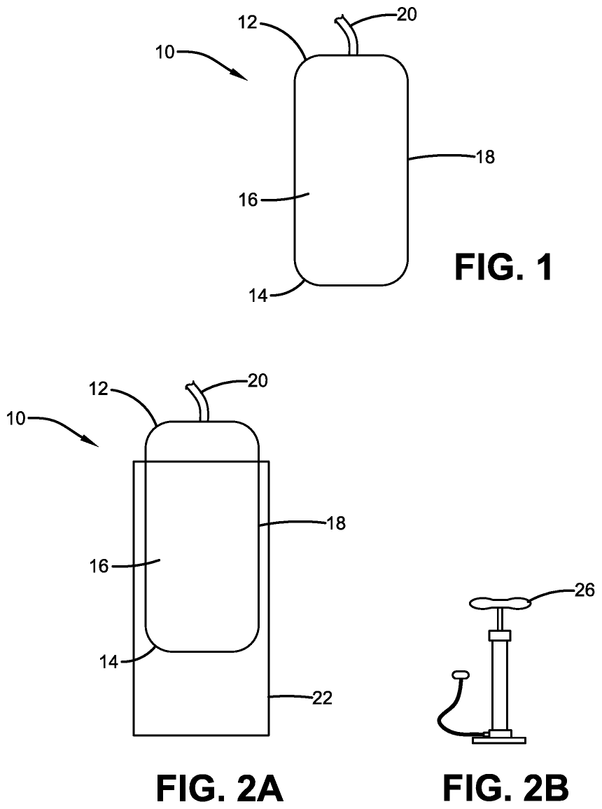

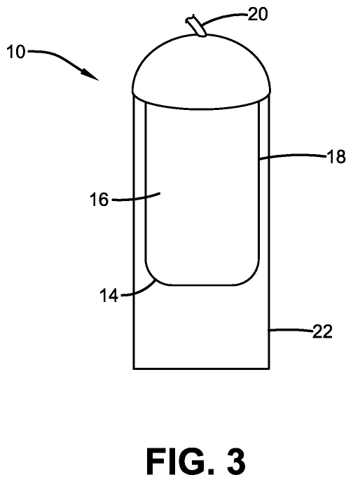

With reference now to FIGS. 1-3, the presenting teaching includes an inflatable system 10 having a body 18, a top 12, a bottom 14, an interior cavity 16, and a fluid inlet 20. In one aspect of the present teaching, the top 12 and the bottom 14 are on opposite sides of the body 18, approximately parallel to one another. The fluid inlet 20 is located on the top 12 of the body 18, wherein the fluid inlet 20 allows the entry of fluid into the interior cavity 16 of the body 18. The inflatable system 10 is made of a material which allows for stretching when the inflatable system 10 is inflated.

With reference now to FIGS. 1-3, the inflatable system 10 is in the sewer 22, such that a portion of the top 12 of the body 18 remains above a floor 24. In one aspect of the present teaching, when using an approximately five inch diameter sewer 22, the body 18 has an uninflated length of approximately fourteen inches long and an uninflated width of about four inches, the stem opening can be about five inches long, and the top 12 of the body 18 can stick out above the floor 24 by about two inches. A perimeter can be drawn on the basement floor around the inflatable system 10 and the sewer 22, so that people can be made aware of the inflatable system 10. This can be a dotted line two inches outside the perimeter of the sewer 22, and the line can be different colors in order to be more visible.

With continuing reference to FIGS. 1-3, in one aspect of the present teachings, a pump 26 is attached to the fluid inlet 20 in order to fill the interior cavity 16 with air. Upon receiving the air, the body 18 increases in size to create a substantially water tight seal with the sewer 22. In one aspect of the present teachings, the inflated body 18 has an inflated length of about 16.5 inches and an inflated width of five inches, so that an inflated top portion 28 extends approximately four inches above the floor 24. Once the body 18 is inflated such that a substantially watertight seal is created with the sewer 22, the pump 26 can be disconnected from the fluid inlet 20. It is to be understood that any type of pump for inserting fluid into the body 18 can be used, as long as chosen using sound engineering judgment. It is also to be understood that any type of fluid inlet 20 for allowing the fluid to enter the body 18 can be used, as long as chosen using sound engineering judgment. It is further to be understood that the dimensions of the inflatable system 10 are not critical, as long as the inflatable system 10 creates the substantially watertight seal.

With continuing reference to FIGS. 1-3, in one aspect of the present teachings, once the need for the inflatable system 10 to no longer create a watertight seal with the sewer 22, the inflatable system 10 can be deflated back down to its original size.

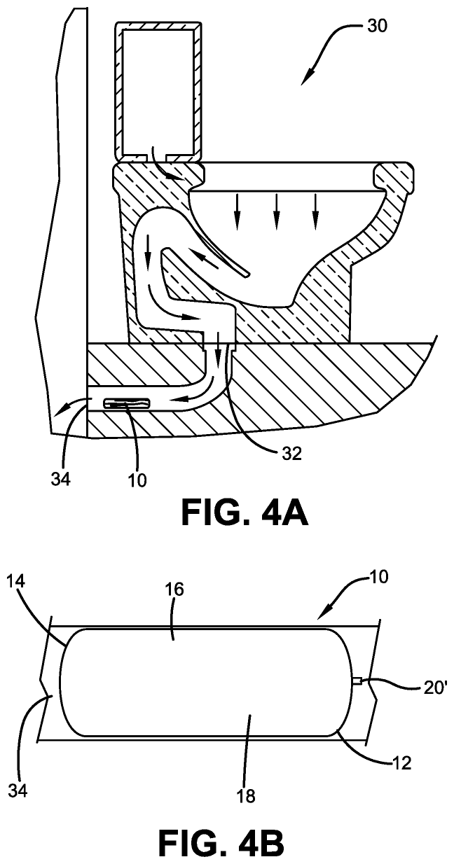

With reference to FIGS. 1-4B, in one aspect of the present teachings, the system 10 can be installed on a toilet 30. The system 10 could be inserted either in the outlet 32 at the base of the toilet 30, or a second outlet 34 underneath the toilet 30. FIG. 4A shows the system 10 inflated in a pipe 36 of the toilet. FIG. 4B is an exploded cutaway view showing the system 10 inflated in the pipe 36. A fluid inlet 20′ in FIG. 4B can be a device that allows for the physical pumping of the body 18, but in one aspect of the present teaching can also be a remotely controlled fluid inlet 20′, such that the body 18 can be inflated and deflated remotely, since access to the system could be difficult. It is also to be understand that any of the aspects of the present teachings can be controlled remotely, not matter where located.

Clause 1—An inflatable watertight system, the system including a body, wherein the body has a top and a bottom, an interior cavity within the body, a fluid inlet on the top of the body, and a rigid pipe, wherein the body is located within the rigid pipe, wherein the body is made of an inflatable material, wherein the body creates a watertight seal in the rigid pipe when inflated.

Clause 2—The system of clause 1, wherein the inflatable material is chosen from the group consisting of: polyvinyl chloride, polyurethane, chlorosulfunated polyethylene with polychloroprene, polyvinyl chloride coated vinyl, polyvinyl chloride coated nylon, oxford woven cloth, polyvinyl chloride tarpaulin, cloth-reinforced polyurethane, and synthetic rubber.

Clause 3—The system of clauses 1 or 2, wherein the fluid inlet accepts air.

Clause 4—The system of clauses 1-3, wherein the body is only partially within the rigid pipe.

Clause 5—The system of clauses 1-4, wherein the top of the body partially extends outside the rigid pipe when the body is inflated.

Clause 6—The system of clauses 1-5, wherein the fluid inlet can be controlled remotely.

Clause 7—The system of clauses 1-6, wherein the rigid pipe is chosen from the group consisting of a sewer drain, a basement drain, and a toilet pipe.

Clause 8—A method for creating a watertight seal in an associated rigid pipe, the method including the steps of inserting an inflatable system into the rigid pipe, wherein the inflatable system includes a body, wherein the body has a top and a bottom, wherein the body is made of an inflatable material, an interior cavity within the body, and a fluid inlet on the top of the body, inflating the interior cavity via the fluid inlet, thereby creating a watertight seal in the rigid pipe.

Clause 9—The method of clause 8, wherein the inflatable material is chosen from the group consisting of: polyvinyl chloride, polyurethane, chlorosulfunated polyethylene with polychloroprene, polyvinyl chloride coated vinyl, polyvinyl chloride coated nylon, oxford woven cloth, polyvinyl chloride tarpaulin, cloth-reinforced polyurethane, and synthetic rubber.

Clause 10—The method of clauses 8 or 9, wherein the fluid inlet accepts air.

Clause 11—The system of clauses 8-10, wherein the body is only partially within the rigid pipe.

Clause 12—The system of clauses 8-11, wherein the top of the body partially extends outside the rigid pipe when the body is inflated.

Clause 13—The system of clauses 8-12, wherein the fluid inlet can be controlled remotely.

Clause 14—The system of clauses 8-13, wherein the rigid pipe is chosen from the group consisting of a sewer drain, a basement drain, and a toilet pipe.

Non-limiting aspects have been described, hereinabove. It will be apparent to those skilled in the art that the above methods and apparatuses may incorporate changes and modifications without departing from the general scope of the present subject matter. It is intended to include all such modifications and alterations in so far as they come within the scope of the appended claims or the equivalents thereof.

Having thus described the present teachings, it is now claimed:

I/we claim:

1. An inflatable watertight system, the system comprising:
a body, wherein the body has a top and a bottom;
an interior cavity within the body;
a fluid inlet on the top of the body; and
a rigid pipe, wherein the body is located within the rigid pipe, wherein the body is made of an inflatable material, wherein the body creates a watertight seal in the rigid pipe when inflated.

2. The system of claim 1, wherein the inflatable material is chosen from the group consisting of: polyvinyl chloride, polyurethane, chlorosulfunated polyethylene with polychloroprene, polyvinyl chloride coated vinyl, polyvinyl chloride coated nylon, oxford woven cloth, polyvinyl chloride tarpaulin, cloth-reinforced polyurethane, and synthetic rubber.

3. The system of claim 2, wherein the fluid inlet accepts air.

4. The system of claim 3, wherein the body is only partially within the rigid pipe.

5. The system of claim 3, wherein the top of the body partially extends outside the rigid pipe when the body is inflated.

6. The system of claim 5, wherein the fluid inlet can be controlled remotely.

7. The system of claim 3, wherein the rigid pipe is chosen from the group consisting of: a sewer drain, a basement drain, and a toilet pipe.

8. The system of claim 7, wherein the body is only partially within the rigid pipe.

9. The system of claim 7, wherein the top of the body partially extends outside the rigid pipe when the body is inflated.

10. A method for creating a watertight seal in an associated rigid pipe, the method comprising the steps of:
inserting an inflatable system into the rigid pipe, wherein the inflatable system comprises:
a body, wherein the body has a top and a bottom, wherein the body is made of an inflatable material;
an interior cavity within the body; and
a fluid inlet on the top of the body; and
inflating the interior cavity via the fluid inlet, thereby creating a watertight seal in the rigid pipe.

11. The method of claim 10, wherein the inflatable material is chosen from the group consisting of: polyvinyl chloride, polyurethane, chlorosulfunated polyethylene with polychloroprene, polyvinyl chloride coated vinyl, polyvinyl chloride coated nylon, oxford woven cloth, polyvinyl chloride tarpaulin, cloth-reinforced polyurethane, and synthetic rubber.

12. The method of claim 11, wherein the fluid inlet accepts air.

13. The method of claim 12, wherein the body is only partially within the rigid pipe.

14. The method of claim 12, wherein the top of the body partially extends outside the rigid pipe when the body is inflated.

15. The method of claim 14, wherein the fluid inlet can be controlled remotely.

16. The method of claim 12, wherein the rigid pipe is chosen from the group consisting of: a sewer drain, a basement drain, and a toilet pipe.

17. The method of claim 16, wherein the body is only partially within the rigid pipe.

18. The method of claim 16, wherein the top of the body partially extends outside the rigid pipe when the body is inflated.
